(19) United States
(12) Patent Application Publication
(10) Pub. No.: US 2026/0058113 A1
(43) Pub. Date: Feb. 26, 2026

(54) APPARATUS AND METHOD OF DISCHARGING DRY ELECTRODE MIXTURE

(71) Applicants: Hyundai Motor Company, Seoul (KR); Kia Corporation, Seoul (KR)

(72) Inventor: Hyun Jin Kim, Hwaseong (KR)

(21) Appl. No.: 18/953,937

(22) Filed: Nov. 20, 2024

(30) Foreign Application Priority Data
Aug. 26, 2024 (KR) 10-2024-0114077

(51) Int. Cl. H01M 4/04; H01M 4/02; H01M 4/525; H01M 4/583; H01M 4/62

(52) U.S. Cl. CPC H01M 4/0404; H01M 2004/027; H01M 2004/028; H01M 4/525; H01M 4/583; H01M 4/623; H01M 4/625

(57) ABSTRACT

A method of discharging a dry electrode mixture, includes mixing the dry electrode mixture in a mixer, and disposing a movable pipe in the mixer and performing vacuum transport of the dry electrode mixture through a suction part of the movable pipe. The method comprises mixing the dry electrode mixture, including an electrode active material, conductive material, and binder, in a mixer with a rotatable chamber and blades. A movable pipe with a suction part, having a lower hole and vertically elongated side openings, is positioned within the mixer. A sensor detects the pipe's position to perform iterative discharge cycles, incrementally lowering the pipe until a predetermined lower set position is reached. The final discharge cycle is conducted with the chamber rotating at low speed, after which the pipe is raised. The system includes a movable pipe, suction part, and vacuum conveyor, enabling efficient, clumping-minimized discharge.

### CROSS-REFERENCE TO RELATED APPLICATION

This application claims under 35 U.S.C. § 119(a) the benefit of Korean Patent Application No. 10-2024-0114077, filed on Aug. 26, 2024, the entire contents of which are incorporated herein by reference.

### BACKGROUND

### Technical Field

The present disclosure relates to manufacture of a dry electrode for secondary batteries.

### Background Art

Recently, applications of rechargeable secondary batteries are expanding to various fields from small electronic devices to large energy storage systems. Particularly, research and development of secondary batteries is being actively conducted due to rapid growth of the electric vehicle market.

Electrodes of secondary batteries have generally been manufactured through a wet process. In the wet process, a slurry is prepared by dissolving an electrode active material, a binder, and a conductive material included in an electrode in a solvent. However, recently, a dry process that may increase the energy density of a battery compared to the wet process without using the solvent required in the wet process has been receiving much attention.

Compared to the wet electrode manufacturing process, in the dry electrode manufacturing process, manufacturing time and costs may be reduced because no solvent is used, and a dry electrode film having a high energy density may be obtained because the thickness of the dry electrode film may be controlled.

In the dry process of the electrode, a mixture is prepared by mixing an electrode active material, a conductive material, and a binder without a solvent, and a dry electrode film is formed by performing a film formation process through pressing or calendering. Then manufacture of the electrode may be completed by bonding the formed dry electrode film to a current collector.

The dry electrode mixture is discharged from the mixer and transported to a press or a post-process. However, the dry electrode mixture has a clumping tendency, causing a difficulty in transporting the dry electrode mixture using a general method.

### SUMMARY OF THE DISCLOSURE

The present disclosure has been made in an effort to solve the above-described problems associated with the prior art, and it is an object of the present disclosure to provide an apparatus and method of discharging a dry electrode mixture that may facilitate discharge of the dry electrode mixture from a mixer.

The objects of the present disclosure are not limited to the above-mentioned objects, and other objects not mentioned herein will be clearly understood by one having ordinary skill in the art to which the present disclosure pertains from the following description.

In order to achieve the above-described objects of the present disclosure and perform characteristic functions of the present disclosure, which will be described later, features of the present disclosure are as follows.

In one aspect, a method of discharging a dry electrode mixture is provided, the method comprising: a) mixing the dry electrode mixture; and b) disposing a pipe within the mixer and performing vacuum transport of the dry electrode mixture through a suction part of the pipe. In preferred aspects, the mixing may be substantially complete, e.g. at least 70, 80, 90, 95, 98 or 99 percent of the mixing step is completed and thereafter the pipe if disposed within the dry electrode mixture. In preferred aspects, the pipe may be a movable pipe, e.g. that the pipe is capable of being moved in the mixture including by a moving apparatus separate from direct manual agitation such as a driver unit.

In a further aspect, the present disclosure provides a method of discharging a dry electrode mixture, including completing mixing of the dry electrode mixture in a mixer, and disposing a movable pipe within the mixer and performing vacuum transport of the dry electrode mixture through a suction part of the movable pipe.

Performing the vacuum transport may include lowering the movable pipe to a first position within the mixer; and performing the vacuum transport at the first position during a first discharge cycle.

The method may further include detecting the first position by a sensor, wherein the first position is a point where the movable pipe touches a surface of the dry electrode mixture before the first discharge cycle is completed.

The method may further include operating the mixer for a predetermined time after the first discharge cycle is completed.

The method may further include lowering the movable pipe to a second position within the mixer; and performing the vacuum transport at the second position during a second discharge cycle.

The method may further include detecting the second position by a sensor, wherein the second position is a point where the movable pipe touches a surface of the dry electrode mixture after the first discharge cycle is completed.

The method may further include operating the mixer for a predetermined time after the second discharge cycle is completed.

The method may further include lowering the movable pipe to a third position within the mixer; determining if the third position corresponds to a predetermined lower set position based on information detected by a sensor; and performing the vacuum transport during a third discharge cycle.

The method may further include moving the movable pipe outside the mixer after the third discharge cycle is completed.

The method may further include rotating a chamber, which is rotatably disposed in the mixer before the third discharge cycle is completed.

In some embodiments, one or more openings are formed on a side surface of the suction part, enabling the dry electrode mixture to enter and exit through these openings, and wherein a vertical length of each of the openings is longer than a horizontal length of each of the openings.

The method may further include forming a film from the vacuum-transported dry electrode mixture.

In another aspect, a method of discharging a dry electrode mixture comprises completing mixing of the dry electrode mixture in a mixer, disposing a movable pipe in the mixer, performing vacuum transport of the dry electrode mixture through a suction part of the movable pipe, and forming a film from the vacuum-transported dry electrode mixture.

In another aspect, the present disclosure provides a system for discharging a dry electrode mixture, including a movable pipe configured to move into a mixer for the dry electrode mixture, a suction part mounted on the movable pipe and including one or more openings formed in a side surface of the suction part, and a vacuum conveyer configured to perform vacuum transport through the movable pipe.

The mixer may include a rotatable chamber; and one or more rotatable blades positioned within the chamber.

The system may further include a driving cylinder configured to move the movable pipe.

The system may further include a flexible pipe configured to connect the movable pipe to the vacuum conveyer.

The system may further include a sensor configured to detect a position of the movable pipe within the mixer.

A vertical length of each of the openings may be longer than a horizontal length of each of the openings.

The system may further include a sensor configured to detect a position of the movable pipe within the mixer; an electric cylinder configured to move the movable pipe; and a controller configured to receive detection information from the sensor and control operation of the electric cylinder based on the received detection information.

As discussed, the method and system suitably include use of a controller or processer.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 schematically illustrates a process of manufacturing a dry electrode;

FIG. 2 illustrates a mixer according to some embodiments of the present disclosure;

FIG. 3A illustrates the mixer according to some embodiments of the present disclosure;

FIGS. 3B and 3C illustrate different opening and closing methods of the mixer of FIG. 3A;

FIGS. 4A, 4B, and 4C illustrate a mixer and a discharge system according to some embodiments of the present disclosure, showing the operation process of the discharge system;

FIG. 5 is a bottom view of a suction part of the discharge system according to some embodiments of the present disclosure;

FIGS. 6A and 6B are side views of a suction part of the discharge system, respectively, according to some embodiments of the present disclosure;

FIGS. 7A and 7B illustrate a support structure of the discharge system according to some embodiments of the present disclosure;

FIG. 8A illustrates a mixer and a discharge system according to some embodiments of the present disclosure;

FIG. 8B is a plan view seen from V1 of FIG. 8A;

FIGS. 9A, 9B, and 9C illustrate the state of a dry electrode mixture in a mixer without a suction part in a discharge system according to some embodiments of the present disclosure;

FIG. 10 is a flow function graph of the dry electrode mixture; and

FIG. 11 is a flowchart of a method of discharging the dry electrode mixture according to some embodiments of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions set forth in embodiments of the present disclosure will be merely exemplarily given to describe the embodiments depending on the concept of the present disclosure, and the embodiments depending on the concept of the present disclosure may be embodied in different forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present disclosure will be described in detail with reference to the accompanying drawings.

A dry electrode may be manufactured from a dry electrode mixture M and a current collector without a solvent. The dry electrode mixture M may be a mixture including an electrode active material, a conductive material (or a conductive additive or a conducting agent), and a binder. In addition, the dry electrode mixture M may further include an additive.

The dry electrode may be a cathode or an anode. In some embodiments, when a cathode is manufactured, the electrode active material may include a cathode active material. As a non-limiting example, the cathode active material may include LCO(LiCoO₂), NCM(Li(Ni,Co,Mn)O₂), NCA(Li(Ni,Co,Al)O₂, LMO(LiMnO₄), LFP(LiFePO₄) or sulfur.

In some embodiments, when an anode is manufactured, the electrode active material may include an anode active material. For example, the anode active material may include natural graphite, artificial graphite, mesocarbon microbeads (MCMB), or a silicon-based active material.

The conductive material may include a carbon-based conductive material. For example, the conductive material may include carbon black, acetylene black, carbon fibers, or carbon nanotube.

The binder may include polyvinylidene fluoride (PVDF), polytetrafluoroethylene (PTFE), or a copolymer including the same.

As the additive, a solid polymer electrolyte, such as poly (ethylene oxide) (PEO), or an oxide-based or sulfide-based solid electrolyte component may be used.

The dry electrode material may include 70 weight % (wt %) to 99.9 wt % of the electrode active material, 0.1 wt % to 20 wt % of the conductive material, and 0.1 wt % to 20 wt % of the binder. Here, the additive may be added at a ratio of 0 to 20 wt %.

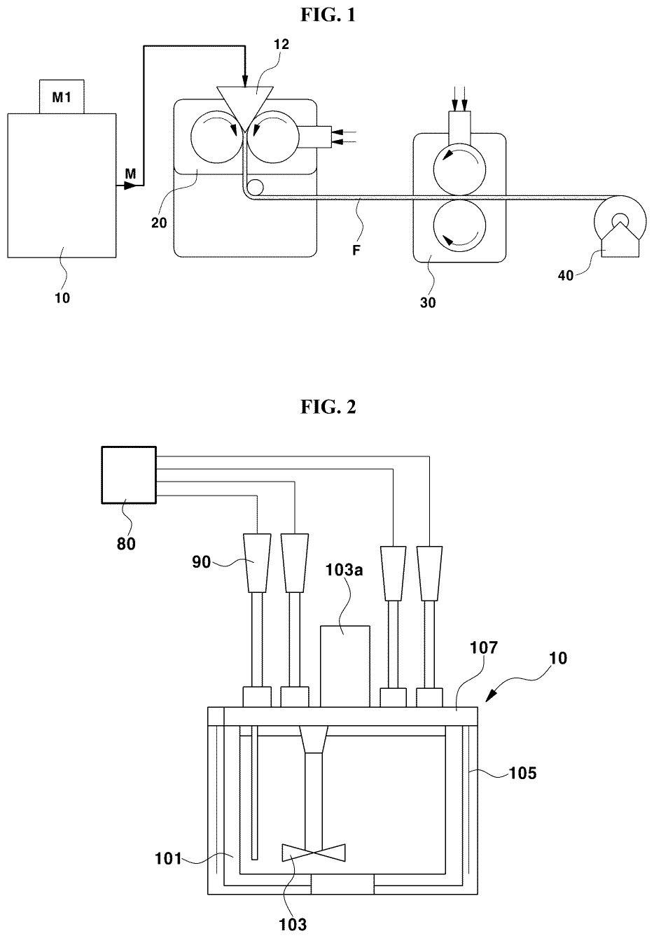

As shown in FIG. 1, the dry electrode mixture M is manufactured into a dry electrode film F through a series of film formation processes in which heat and pressure are applied. First, the dry electrode mixture M including the electrode active material, the conductive material, and the binder is mixed by a mixer 10 at a predetermined rate for a predetermined time. As a non-limiting example, the dry electrode mixture M may be manufactured through a high shear mixer using rotation, a fluid mixer using air, or the like. The predetermined time and rate may be adjusted through changes in the rotational speed and operating time of the mixer 10.

The dry electrode mixture M mixed in the mixer 10 may be formed into the dry electrode film F by a film formation apparatus. Specifically, the dry electrode mixture M mixed in the mixer 10 may be directed to a feeder 12 or a roll press 20. The dry electrode mixture M may be primarily pressed into the dry electrode film F by the upstream roll press 20. The upstream roll press 20 rotates while providing pressing force to form the dry electrode mixture M into the dry electrode film F. The dry electrode film F primarily formed from the dry electrode mixture M may be additionally pressed by a downstream roll press 30, and the thickness of the dry electrode film F may be adjusted through pressing. Thereafter, the dry electrode film F is wound by a winder 40. Then the dry electrode film F may be bonded or laminated to the current collector, thereby manufacturing a dry electrode.

As used herein, the dry electrode mixture M means a powder in which the electrode active material, the conductive material, and the binder are appropriately mixed and dispersed through the mixer 10, and which is in a state of being formable into the film F when pressed by the film formation apparatus, i.e., the roll press 20. In the present disclosure, a mixture in which the electrode active material, the conductive material, and the binder simply exist together is referred to as a dry electrode raw material MI in order to distinguish this mixture from the dry electrode mixture M.

The dry electrode mixture M may be considered as being appropriately mixed and dispersed through fibrillization of the binder and complexation of the electrode active material and the conductive material. In other words, in order to manufacture a dry electrode in the form of a freestanding film, the complexation of the electrode active material and the conductive material plays an important role along with the fibrillization of the binder. The complexation of the electrode active material and the conductive material may be explained as coating of the conductive material on the surface of the electrode active material. The coating of the electrode active material by the conductive material may be achieved by a high shear force applied by the mixer 10. The fibrillization of the binder may be explained as the binder being stretched thinly and long by the high shear force from the mixer 10 to connect the complexed electrode active material and conductive material through a network. The fibrillization of the binder may particularly allow the binder to serve as a structure so that the manufactured dry electrode may become a freestanding film.

The complexation of the electrode active material and the conductive material may cause the conductive material to be uniformly dispersed and coated on the surface of the electrode active material to form electron transfer channels between electrode active material particles and improve electron mobility. Further, the complexation may also affect the characteristics of collision energy between particles during the fibrillization of the binder.

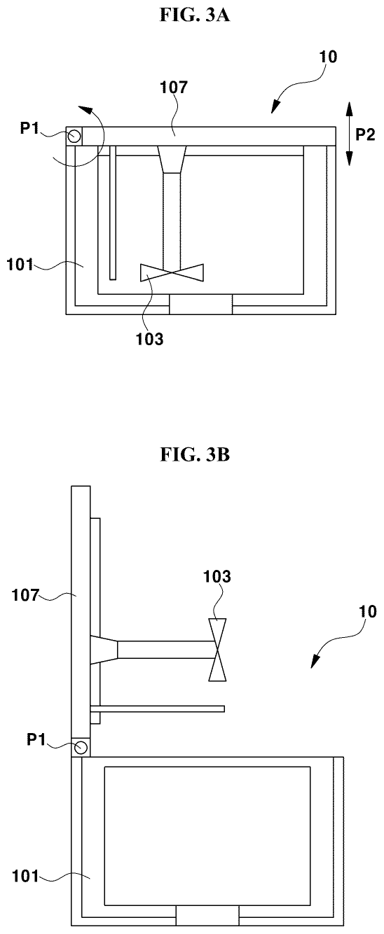

Referring to FIG. 2, in some embodiments of the present disclosure, the mixer 10 includes a chamber 101 and a blade 103. While a general mixer is configured such that a chamber is fixed and only blades rotate, the mixer 10 for the dry electrode mixture M is configured such that both the chamber 101 and the blade 103 rotate.

In addition, the mixer 10 may include a cooling jacket 105. In one embodiment, the cooling jacket 105 may be built within the mixer 10. In another embodiment, the cooling jacket 105 may be disposed to surround the outer circumference of the chamber 101. The cooling jacket 105 is configured such that a coolant is circulated therein. For example, the coolant may be introduced into and discharged from the cooling jacket 105 through the lower portion of the mixer 10.

A motor 103a may be disposed on a lid 107 of the mixer 10. The motor 103a may provide rotational force to the blade 103 of the mixer 10. Further, the dry electrode raw material M1 including the electrode active material, the conductive material, and the binder is supplied through the lid 107. The dry electrode raw material M1 may be measured in a predetermined amount through a measuring system 80. The measured dry electrode raw material M1 may be vacuum-transported from the measuring system 80 by vacuum conveyers 90 and may be introduced into the chamber 101 through the lid 107.

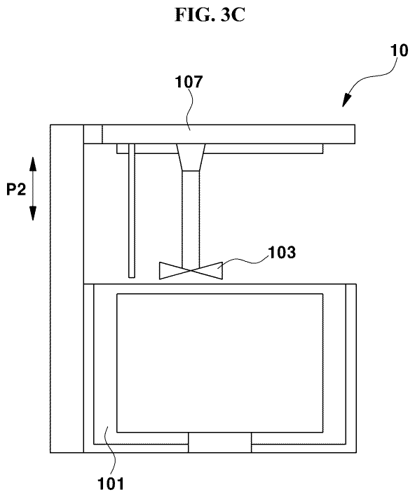

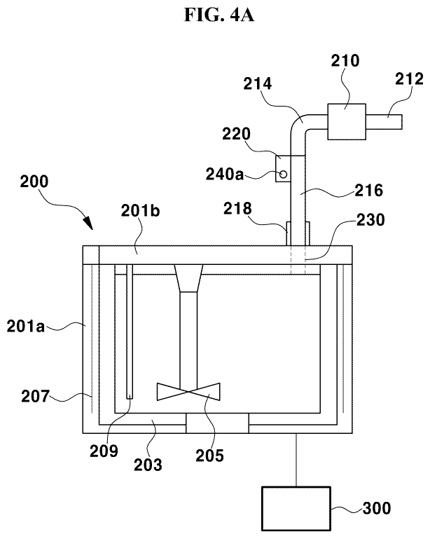

As shown in FIGS. 3A, 3B, and 3C, the dry electrode mixture M in the mixer 10 may be discharged by opening the lid 107. As shown in FIGS. 3A and 3B, the closed lid 107 may be rotated around a pivot point P1. In another example, as shown in FIGS. 3A and 3C, the closed lid 107 may be opened by sliding in a direction P2. When the lid 107 is opened, the chamber 101 is detached and the dry electrode mixture M may be discharged.

As described above, the mixer 10 may have no outlet formed in the bottom or side surface of the mixer 10 because both the chamber 101 and the blade 103 rotate and the cooling jacket 105 is present. Therefore, the dry electrode mixture M may be discharged by opening the lid 107 and detaching the chamber 101. However, this discharge method may be inefficient, considering a time required for discharge of the dry electrode mixture M, a level of difficulty of work, a possibility of automation, and space utilization.

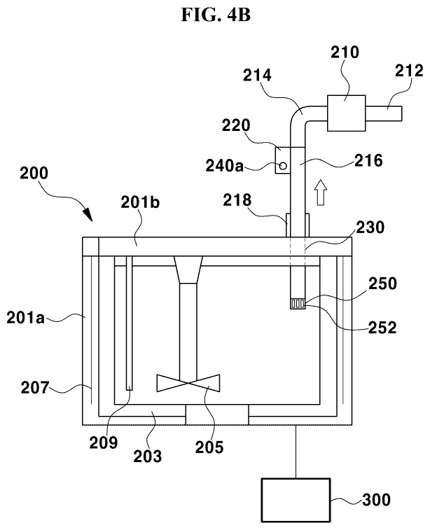

Therefore, as shown in FIGS. 4A, 4B and 4C, a mixer 200 according to some embodiments of the present disclosure may discharge a dry electrode mixture M in a chamber 203 without opening a lid 201b.

The mixer 200 includes an outer housing 201a and the lid 201b. The lid 201b may be openable. The chamber 203 is disposed within the outer housing 201a. The chamber 203 is configured to rotate with respect to the outer housing 201a.

The mixer 200 includes one or more rotatable blades 205. During the mixing operation of the mixer 200, the blade 205 and the chamber 203 may rotate together. For example, the blade 205 and the chamber 203 may rotate in opposite directions.

In addition, the mixer 100 may include a cooling jacket 207. In one embodiment, the cooling jacket 207 may be built in the chamber 203. In another embodiment, the cooling jacket 208 is disposed to surround the outer circumference of the chamber 203 and is configured such that a coolant is circulated therein. For example, the coolant may be introduced into and discharged from the cooling jacket 203 through the lower portion of the mixer 200.

The mixer 200 may further include a scraper 209. The scraper 209 may scrape off materials attached to the chamber 203 by centrifugal force during the operation of the mixer 200 to allow the materials to participate in mixing again. Further, the mixer 200 may further include a driver, such as the motor 103a, which is omitted in the drawings.

The mixer 200 includes a discharge system. The discharge system of the mixer 200 may transport the dry electrode mixture M in the chamber 203 to the outside of the chamber 203 without opening the lid 201b. The lid 201b may be provided with a valve 230 capable of opening or closing a passage so that the discharge system may enter the mixer 200 therethrough.

According to some embodiments of the present disclosure, the discharge system includes a vacuum conveyer 210 and pipes 214 and 216. The vacuum conveyer 210 is configured to transport the dry electrode mixture M in the chamber 203 in a vacuum transport manner. The pipes 214 and 216 communicate with the chamber 203 through the lid 201b, and the dry electrode mixture M suctioned through the pipes 214 and 216 may be discharged to the outside of the mixer 200 by the operation of the vacuum conveyer 210. A destination pipe 212 connected to the vacuum conveyer 210 may be connected to a subsequent process. For example, the dry electrode mixture M may be transported to the feeder 12 or the press 20 through the destination pipe 212.

The lengths of the pipes 214 and 216 may be adjusted. Accordingly, the pipes 214 and 216 may reach the bottom of the chamber 203. In some embodiments, the pipes 214 and 216 may include a flexible pipe 214 and a movable pipe 16. The flexible pipe 214 may have a variable length. For example, the flexible pipe 214 may be an accordion-shaped corrugated pipe.

The movable pipe 216 is connected to the flexible pipe 214 and is configured to move. The movable pipe 216 may enter the chamber 203 through the lid 201b. In one example, the movable pipe 216 may enter the chamber 203 while being guided by a guide 218 mounted on the lid 201b. The movable pipe 216 may be moved by a driver, such as an electric cylinder 220. In one example, the movable pipe 216 may be formed of stainless steel.

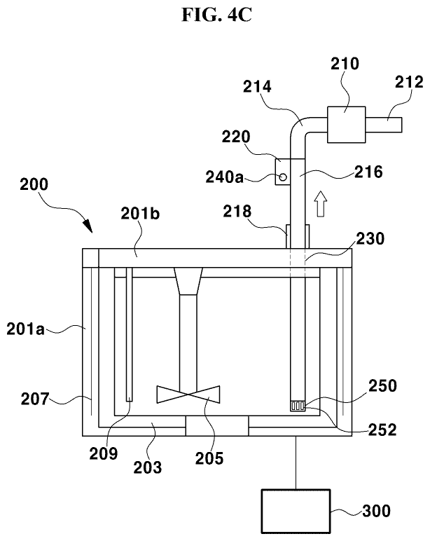

The mixer 200 may include a sensor. Information detected by the sensor may become the basis for determining the position of the movable pipe 216. In one embodiment, the mixer 200 may include a pressure sensor 240a. The pressure sensor 240a allows the position of the movable pipe 216 to be adjusted through pressure applied to the electric cylinder 220 when the movable pipe 216 is lowered. Specifically, when the movable pipe 216 touches the surface of the dry electrode mixture M in the chamber 203 while being moved by the electric cylinder 220, the pressure measured by the pressure sensor 240 increases. Thus, the position of the movable pipe 216 may be determined based on this. As shown in FIG. 5, in another embodiment, the mixer 200 may include one or more piezoelectric elements 240b. The piezoelectric elements 240b may be disposed on the lower portion or a suction part 250 of the movable pipe 216. A plurality of piezoelectric elements 240b may be installed on the lower portion of the suction part 250. For example, at least four piezoelectric elements 240b may be installed. The position of the movable pipe 216 may be determined and adjusted based on electrical signals from the piezoelectric elements 240b.

The movable pipe 216 may be provided with the suction part 250. The suction part 250 may be mounted on the distal end of the movable pipe 216. The proximal end of the movable pipe 216 may be connected to the flexible pipe 214, as described above. The suction part 250 may include a lower hole 251 formed in the bottom surface thereof, as shown in FIG. 5, and one or more openings 252 formed in the side surface of the suction part 250.

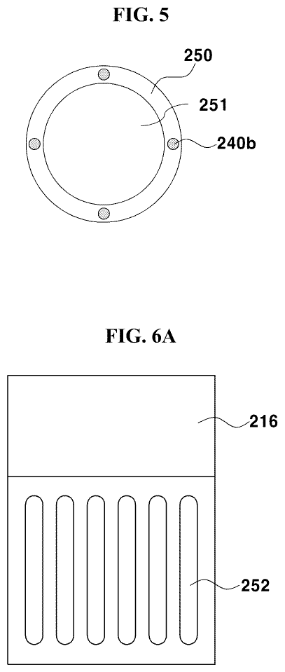

As shown in FIGS. 6A and 6B, the suction part 250 is configured to have a shape that may smoothly draw in a highly cohesive mixture, such as the dry electrode mixture M. Such a shape of the openings 252 may relieve clumping of the dry electrode mixture M and may minimize influence of pressure on the dry electrode mixture M remaining in the chamber 203 while allowing air to enter the movable pipe 216 during vacuum transport.

Particularly, the openings 252 of the suction part 250 may have a shape in which the vertical length of the openings 252 is longer than the horizontal length of the openings 252. When the lower hole 251 or the lower portions of the openings 252 are clogged during vacuum transport, air may be introduced through the upper portions of the openings 252. In this case, the dry electrode mixture M blocking the lower portions of the openings 252 may fall again when the vacuum transport in a corresponding cycle has been finished and be transported during vacuum transport in a subsequent cycle. Therefore, the openings 252 have the shape in which the vertical length of the openings 252 is longer than the horizontal length of the openings 252, and as shown in FIG. 6B, circular openings 252a may not be placed anywhere other than the upper portion of the suction part 250. The circular openings 252a formed in the upper portion of the suction part 250 may contribute to increasing the amount of air introduced through the side surface of the suction part 250.

In the dry electrode mixture M after mixing has been completed, the binder is fibrillized into a small size. However, some particles of the binder are in a state of being partially clumped together in the form of clusters, and the size of these clusters was confirmed to exceed 500 micrometers when observed using an electron microscope. However, considering that, when the dry electrode mixture M is suctioned by the discharge system under a high pressure vacuum (for example, 5 bar or more), two or more clusters may move together through the suction part 250 or the openings 252, the horizontal length of the openings 252 may be set to be 10 or more times (i.e., 0.5 centimeter (cm)) greater than the size of the clusters.

The discharge system may include a controller 300. The controller 300 is configured to control operation of the discharge system. In one embodiment, the controller 300 may collect detection information from the sensors 240a and 240b. In one embodiment, the controller 300 may control operation of the electric cylinder 220. In one embodiment, the controller 300 may control operation of the vacuum conveyer 210. In one embodiment, the controller 300 is configured to control operation of the mixer 200. For example, the controller 300 may control operation of the valve 230, the blade 205, the chamber 203, etc. In one embodiment, the controller 300 may be integrated with a controller configured to control operation of the mixer 200 or a dry electrode manufacturing system or may be configured separately from these controllers.

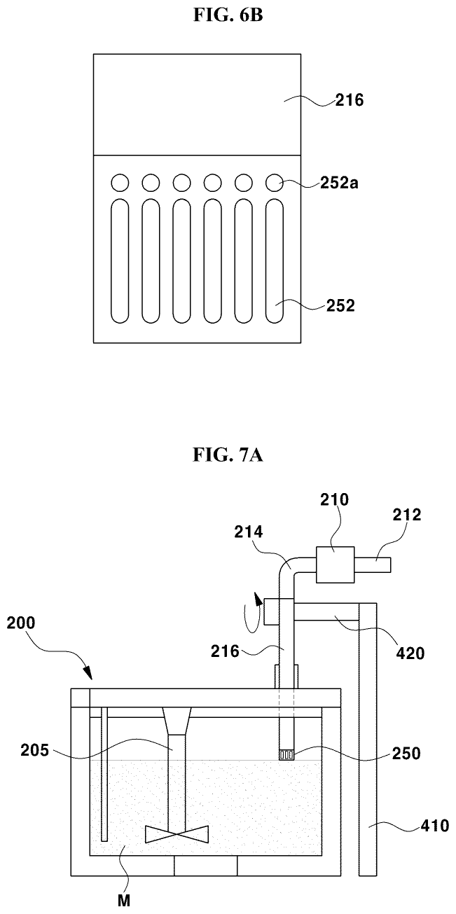

As shown in FIGS. 7A and 7B, the discharge system may include a structure configured to support, particularly, the electric cylinder 220. As shown in FIG. 7A, in some embodiments, the discharge system may include a column 410 and a connection rod 420. The column 410 may be supported by a fixed portion, such as the ground, and the connection rod 420 may be connected perpendicularly to the column 410. The connection rod 420 may support the electric cylinder 220 and the movable pipe 216. Further, the connection rod 420 may be configured to be rotatable while supporting the electric cylinder 220 and the movable pipe 216. This may provide a space for maintenance of the mixer 200. As shown in FIG. 7B, in some embodiments, the discharge system may include a platform 430 and a link 440. The platform 430 may be installed on a fixed portion, such as the ceiling, and the link 440 connected to the platform 430 may support the electric cylinder 220 and the movable pipe 216.

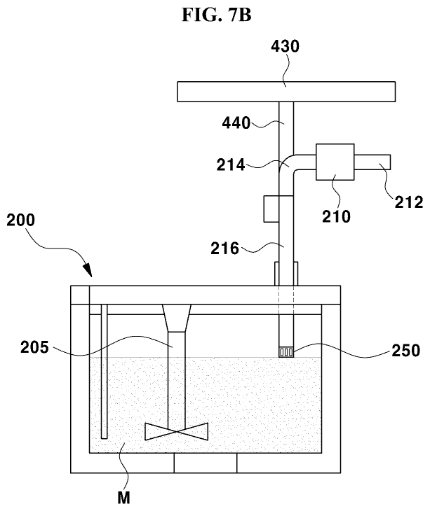

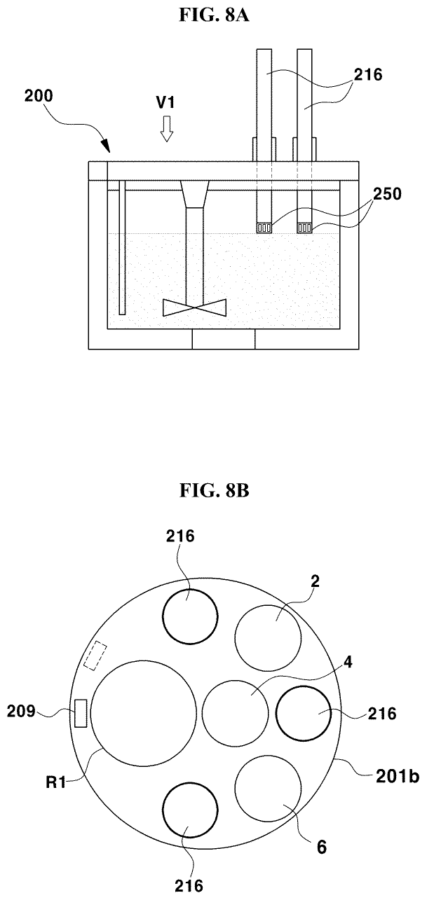

Referring to FIG. 8A, according to some embodiments of the present disclosure, a plurality of movable pipes 216 may be provided. When high-speed discharge is required depending on the speed of the process, a plurality of movable pipes 216 may be used. As shown in FIG. 8B, the plurality of movable pipes 216 may be arranged so as not to interfere with the rotational radius RI of the blade 205, the scraper 209, an electrode active material inlet 2, a conductive material inlet 4, and a binder inlet 6.

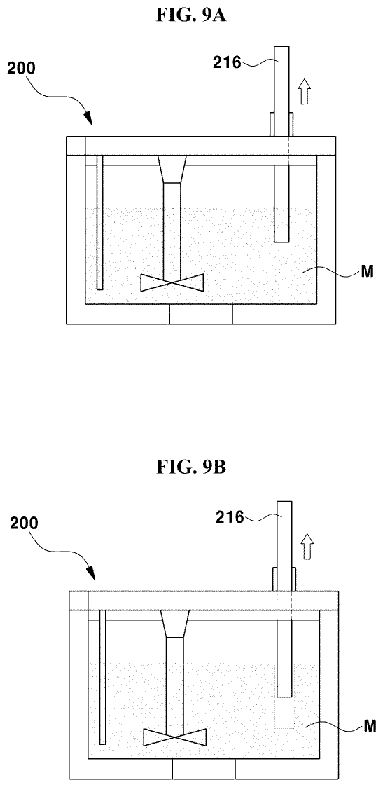

As shown in FIGS. 9A, 9B, and 9C, if the movable pipe 216 without the suction part 250 is inserted into the dry electrode mixture M in the chamber 203 to transport the dry electrode mixture M, an area larger than a vacuum transportable capacity is affected. The dry electrode mixture M around the movable pipe 216 that has not been suctioned is gathered and clumped in a narrow space, and thus acts as a wall and makes it difficult to continuously discharge the dry electrode mixture M.

This characteristics of the dry electrode mixture M may be confirmed in relation to the flow property of the dry electrode mixture M. Measurement of the flow property of the dry electrode mixture M is disclosed in Korean Patent Application No. 10-2023-0021097 filed by the applicant of the present disclosure. Briefly, the flow property of the dry electrode mixture M may be evaluated based on ASTM D6128 of the American Society for Testing and Materials. Shear stresses within a designated range are applied to a certain amount of the dry electrode mixture M (for example, through a mixer), and internal force is measured at the equilibrium state of each shear stress. At a certain point in time after the shear stress has been applied, powder collapse occurs within the dry electrode mixture M, and stress at this time may be measured as the internal force. The measured internal force may be fitted to each applied shear stress, and a differential value at each shear stress may be defined as a flow index.

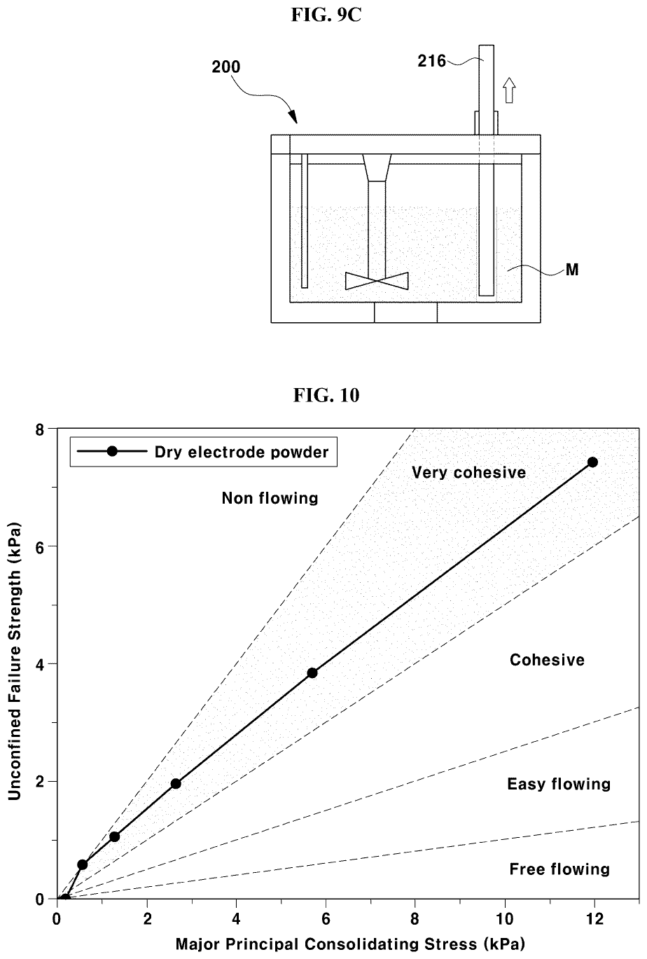

Referring to a flow function graph based on the measured flow index, as shown in FIG. 10, considering the flow index, powder may be located in a free flowing, easy flowing, cohesive, very cohesive, or non-flowing region depending on the characteristics of the powder. Based on the measured flow property, the dry electrode mixture M is mainly located in the very cohesive region, and some of the dry electrode mixture M is located in the cohesive region. Through these results, it may be determined that the dry electrode mixture M has an easily clumping tendency.

Therefore, according to the discharge system according to some embodiments of the present disclosure, instead of inserting the movable pipe 216 into the dry electrode mixture M, vacuum suction is performed at the position of the surface of the dry electrode mixture M, light mixing is performed, and then the movable pipe 216 is moved to the surface of the dry electrode mixture M with a reduced height to perform vacuum suction. Therefore, despite the clumping tendency of the dry electrode mixture M, smooth transport may be enabled.

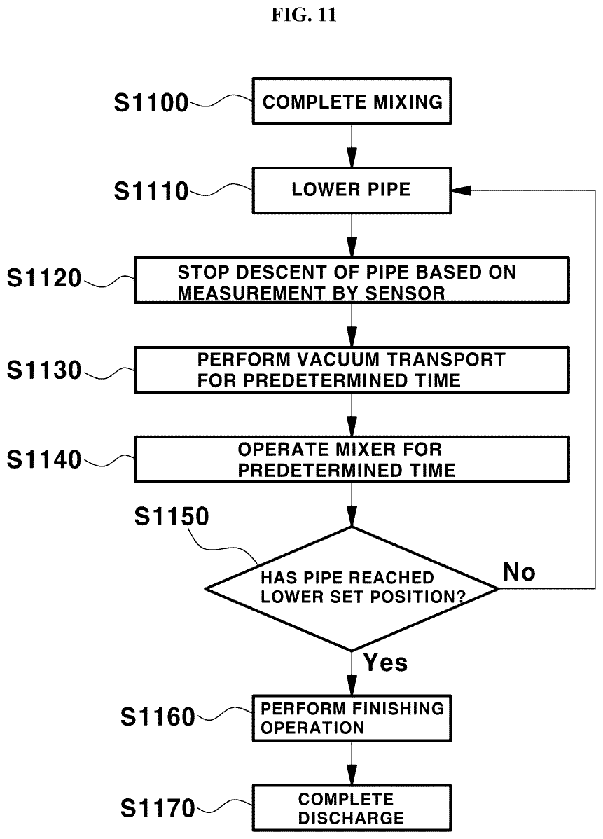

Hereinafter, referring to FIG. 11, the discharge system of the mixer 200 according to some embodiments of the present disclosure is described.

Referring again to FIG. 4A, mixing of the dry electrode mixture M is completed in the mixer 200 at Operation S1100. As the valve 230 is opened by the controller 300, the movable pipe 216 is placed in a state in which the movable pipe 216 is capable of entering the chamber 203.

When the valve 230 is opened, the movable pipe 216 is lowered toward the chamber 203 at Operation S1110. The controller 300 may operate the electric cylinder 220 to lower the movable pipe 216.

Referring again to FIG. 4B, descent of the movable pipe 216 may be stopped based on measurement by the sensors, such as the pressure sensor 240a or the piezoelectric elements 240b, at Operation S1120. When the suction part 250 touches the surface of the dry electrode mixture M in the chamber 203, such contact may be detected by the pressure sensor 240a or the piezoelectric elements 240b. Detected information is transmitted to the controller 300, and the controller 300 is configured to stop the operation of the electric cylinder 220 to stop the descent of the movable pipe 216.

After stopping the descent of the movable pipe 216, vacuum transport is performed for a predetermined time which is a first discharge cycle at Operation S1130. In the first discharge cycle, the vacuum transport is performed for the predetermined time, so the on and off operations are performed.

When the vacuum transport in the first discharge cycle is completed, the blade 205 may be operated at Operation S1140. At this time, the blade 205 is rotated at a low speed (e.g., within a linear speed of 5 m/s) for a predetermined time (a short time, e.g., within 1 minute). The operation of the blade 205 may eliminate and flatten the shape of a walled hole formed in the dry electrode mixture M in the first discharge cycle.

The controller 300 determines whether the movable pipe 216 has reached a lower set position in the chamber 203 at Operation S1150. The lower set position is a position to which the movable pipe 216 is maximally lowered in the chamber 203 and may be detected by the sensor 240a or 240b. The controller 300 may determine whether the movable pipe 216 is reached the lower set position in the chamber 203 based on the detected information.

If the movable pipe 216 has not reached the lower set position, a second discharge cycle is performed in the same manner as the first discharge cycle. A plurality of discharge cycles is performed until the movable pipe 216 reaches the lower set position.

In response to the movable pipe 216 reaching the lower set position, the controller 300 performs the final discharge cycle and raises the movable pipe 216 at Operation S1160). In the final discharge cycle, the chamber 203 rather than the blade 205 rotates at a low speed.

Through this process, discharge of the dry electrode mixture M may be completed at Operation S1170.

In this way, according to the present disclosure, a system and method of discharging a dry electrode mixture that may facilitate discharge of the dry electrode mixture from a mixer are provided.

As is apparent from the above description, the present disclosure provides a system and method of discharging a dry electrode mixture that may facilitate discharge of the dry electrode mixture from a mixer.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method of discharging a dry electrode mixture, the method comprising:
mixing the dry electrode mixture in a mixer; and
disposing a movable pipe within the mixer and performing vacuum transport of the dry electrode mixture through a suction part of the movable pipe.

2. The method of claim 1, wherein performing the vacuum transport comprises:
lowering the movable pipe to a first position within the mixer; and
performing the vacuum transport at the first position during a first discharge cycle.

3. The method of claim 2, further comprising detecting the first position by a sensor,
wherein the first position is a point where the movable pipe touches a surface of the dry electrode mixture before the first discharge cycle is completed.

4. The method of claim 2, further comprising operating the mixer for a predetermined time after the first discharge cycle is completed.

5. The method of claim 4, further comprising:
lowering the movable pipe to a second position within the mixer; and
performing the vacuum transport at the second position during a second discharge cycle.

6. The method of claim 5, further comprising detecting the second position by a sensor,
wherein the second position is a point where the movable pipe touches a surface of the dry electrode mixture after the first discharge cycle is completed.

7. The method of claim 5, further comprising operating the mixer for a predetermined time after the second discharge cycle is completed.

8. The method of claim 7, further comprising:
lowering the movable pipe to a third position within the mixer;
determining if the third position corresponds to a predetermined lower set position based on information detected by a sensor; and
performing the vacuum transport during a third discharge cycle.

9. The method of claim 8, further comprising moving the movable pipe outside the mixer after the third discharge cycle is completed.

10. The method of claim 8, further comprising rotating a chamber, which is rotatably disposed in the mixer before the third discharge cycle is completed.

11. The method of claim 1, wherein one or more openings are formed on a side surface of the suction part, enabling the dry electrode mixture to enter and exit through these openings, and wherein a vertical length of each of the openings is longer than a horizontal length of each of the openings.

12. The method of claim 1, further comprising
forming a film from the vacuum-transported dry electrode mixture.

13. A method of discharging a dry electrode mixture, the method comprising:
mixing the dry electrode mixture, which includes an electrode active material, a conductive material, and a binder, in a mixer configured with both a rotatable chamber and rotatable blades;
positioning a movable pipe with a suction part within the mixer, wherein the suction part includes a lower hole and one or more side openings, each having a vertical length longer than a horizontal length;
detecting a first position of the movable pipe relative to the surface of the dry electrode mixture in the mixer, using at least one sensor;
performing a first discharge cycle by vacuum-transporting the dry electrode mixture through the suction part of the movable pipe positioned at the first position for a predetermined time;
operating the blades of the mixer at a low speed following completion of the first discharge cycle;
iteratively lowering the movable pipe to subsequent positions detected by the sensor until a predetermined lower set position within the mixer is reached, and performing corresponding discharge cycles at each position;
performing a final discharge cycle when the movable pipe reaches the lower set position, wherein the chamber of the mixer rotates at a low speed rather than the blades; and
raising the movable pipe out of the mixer upon completion of the final discharge cycle.

14. A system for discharging a dry electrode mixture, the system comprising:
a movable pipe configured to move into a mixer to produce the dry electrode mixture by mixing a dry electrode active material, a conductive material, and a binder;
a suction part mounted on the movable pipe and comprising one or more openings formed on a side surface of the suction part; and
a vacuum conveyer configured to perform vacuum transport through the movable pipe.

15. The system of claim 14, wherein the mixer comprises:
a rotatable chamber; and
one or more rotatable blades positioned within the chamber.

16. The system of claim 14 further comprising a driving cylinder configured to move the movable pipe.

17. The system of claim 14, further comprising a flexible pipe configured to connect the movable pipe to the vacuum conveyer.

18. The system of claim 14, further comprising a sensor configured to detect a position of the movable pipe within the mixer.

19. The system of claim 14, wherein a vertical length of each of the openings is longer than a horizontal length of each of the openings.

20. The system of claim 14, further comprising:
a sensor configured to detect a position of the movable pipe within the mixer;
an electric cylinder configured to move the movable pipe; and
a controller configured to receive detection information from the sensor and control operation of the electric cylinder based on the received detection information.
